(19) United States
(12) Patent Application Publication
(10) Pub. No.: US 2012/0047722 A1
(43) Pub. Date: Mar. 1, 2012

(54) METHOD FOR SAVING POWER OF AIR CONDITIONER DURING SLEEP

(76) Inventors: Shih-Min YU, Kaohsiung City (TW); Shih-Hsien YU, Kaohsiung City (TW)

(21) Appl. No.: 12/868,692

(22) Filed: Aug. 25, 2010

(51) Int. Cl. B23P 19/04

(52) U.S. Cl. 29/700

(57) ABSTRACT

The present invention is related to a method for saving power of an air conditioner during sleep. According to the present invention, a curtain is mounted above a bed to enclose a small space to form a small air conditioning space, and by placing an indoor unit of a split-typed air conditioner above the small space, the power consumption of the air conditioner during sleep can be reduced.

### FIELD OF THE INVENTION

The present invention is related to a method for saving power of an air conditioner during sleep, and more particularly to a power saving method for forming a small air conditioning space above the bed and arranging an air conditioner in the small air conditioning space during sleep.

### BACKGROUND OF THE INVENTION

The air conditioner seems to become indispensable in hot weather for providing an indoor cool environment, especially in summer and autumn Therefore, during the seasonal peak of electricity consumption, it is inevitable that the power bill will have a significant increase. Particularly, if the air conditioner runs in a larger bedroom during sleep, then the power consumption might be huge owing to the long-term usage, which obviously disobeys the policy of energy saving. Take the air conditioner used in Taiwan as an example. Assumed that a 10000 BTU air conditioner approximately consumes 1 degree (1 kW/hr) of electricity, a room of 16.5 m² with 8.5 hours for air conditioning every day may consume 255 degrees of electricity every month. If every degree of electricity costs 3.75 TWD, then the average power bill will cost 943.5 TWD per month. Since the average period of using air conditioner in Taiwan is approximately 7.5 months, the power bill for air conditioner will be 7076.25 TWD every year. The calculation above is based on a commonly used air conditioner, and if the bedroom is bigger which needs an air conditioner with higher tonnage or multiple air conditioners, then the power consumption and power bill will become more.

### SUMMARY OF THE INVENTION

Therefore, there is a need to develop a method for saving power of an air conditioner during sleep, so as to solve the problems described above. The present invention utilizes a curtain to form a cover above a bed, so as to enclose a small space above the bed, and place an indoor unit of a split-typed air conditioner above the small space to form a small air conditioning space. Since the size of a bed is generally 3.3 m², it will be sufficient to employ a 2000 BTU air conditioner in the small air conditioning space for reducing the power consumption. If it is assumed that the 2000 BTU air conditioner runs 8.5 hours per day and consumes approximately 50 degrees of electricity every month, then based on each degree of electricity costs 3.75 TWD, the average power bill will be 187.5 TWD per month. Averagely, the period of using the air conditioner in Taiwan is approximately 7.5 months, so that the power bill for a 2000 BTU air conditioner will be 1406.3 TWD every year. As compared with the 10000 BTU air conditioner used in a room of 16.5 m², the present invention not only saves cost and electricity, but also conforms to the purpose of energy saving.

Therefore, according to the present invention, the method for saving power of an air conditioner during sleep is characterized in that:

1. By forming a small air conditioning space above the bed, a desired low temperature can be rapidly achieved in a short time for saving electricity.

2. Through the formed small air conditioning space, a smaller air conditioner can be employed to reduce power consumption and also power bill.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional view showing the arrangement of an embodiment according to the present invention;

FIG. 2 is a top view of FIG. 1;

FIG. 3 is a right side view of FIG. 1;

FIG. 4 is a front view showing the arrangement of another embodiment according to the present invention;

FIG. 5 is a right side view of FIG. 4;

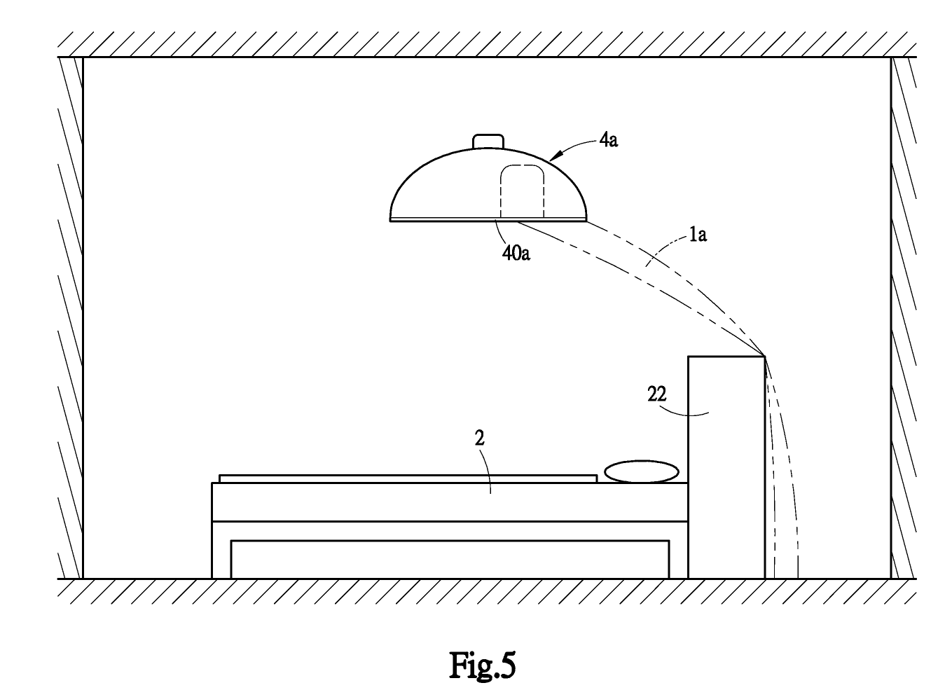

FIG. 6 is a three-dimensional view showing the arrangement of yet another embodiment according to the present invention; and

FIG. 7 is a three-dimensional view showing the arrangement of still another embodiment according to the present invention.

### DESCRIPTION OF THE PREFERRED EMBODIMENT

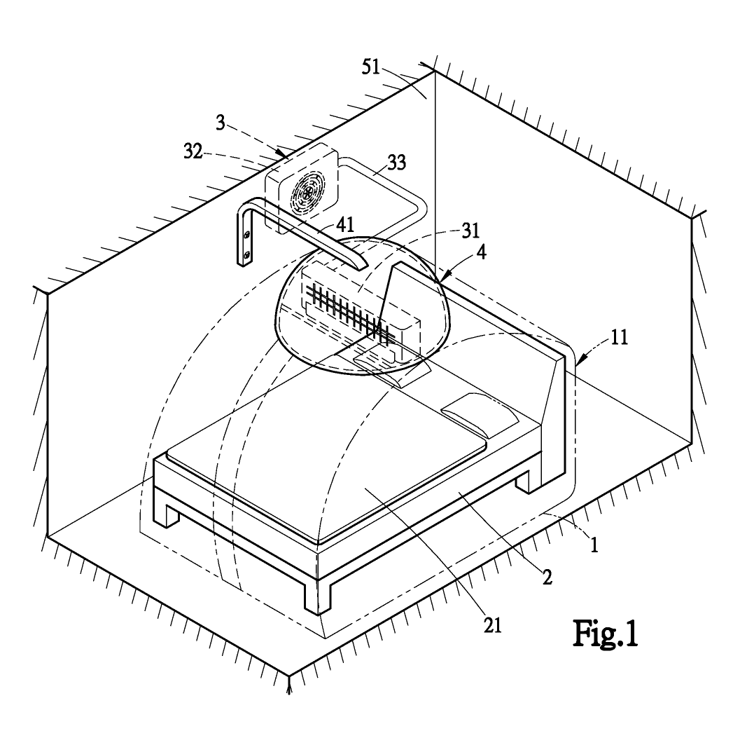

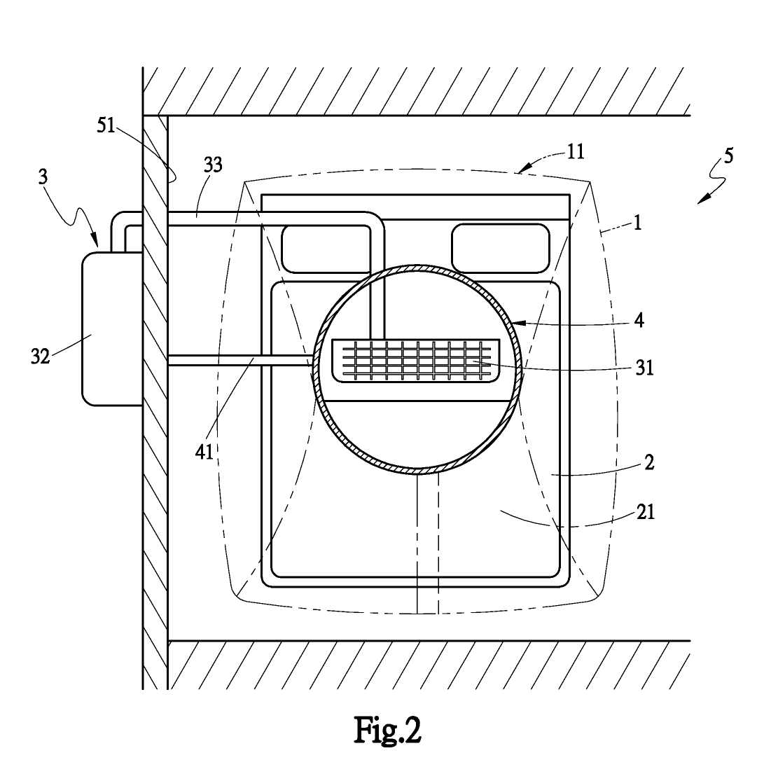

Please refer to FIG. 1 and FIG. 2. The present invention is related to a method for saving power of an air conditioner during sleep, in which utilizes a curtain 1 to form a cover 11 to enclose a small space 21 above a bed 2, and places an indoor unit 31 of a split-typed air conditioner 3 above the small space 21, so as to form a small air conditioning space which can restrict the cool air therein, thereby the desired low temperature can be rapidly achieved in a short time.

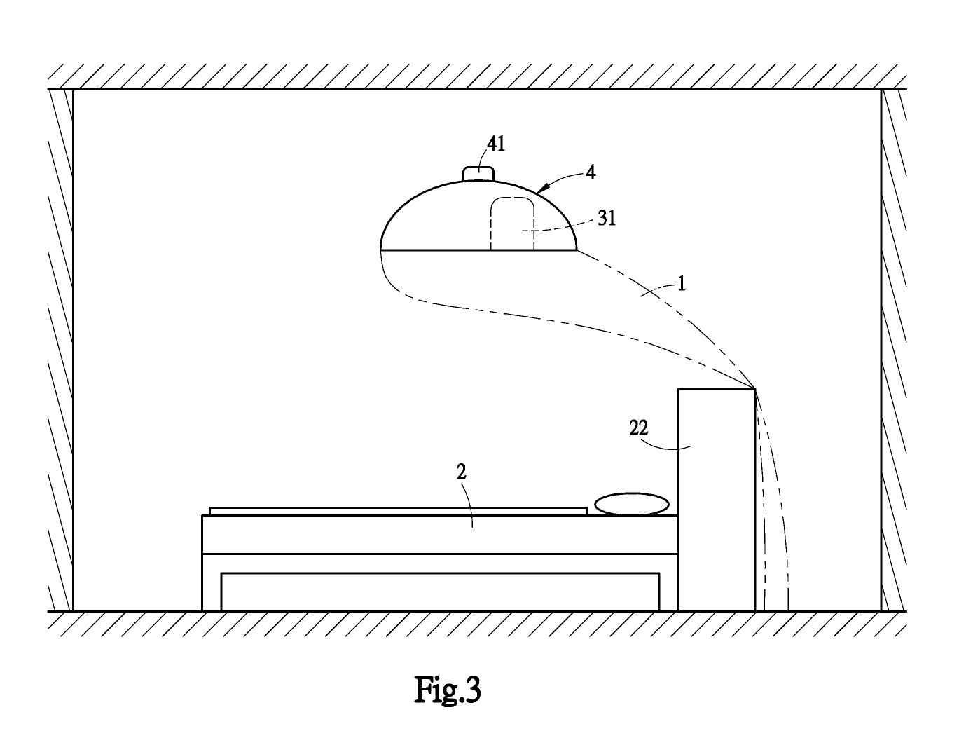

FIG. 1, FIG. 2 and FIG. 3 show an embodiment of the power saving apparatus according to present invention in which a bed 2 of 3.3 m² in the small air conditioning space adopts only a 2000 BTU split-typed air conditioner 3. The power saving apparatus includes:

a split-typed air conditioner 3, having an indoor unit 31 connected to an outdoor unit 32 via a duct 33;

a fixed frame 4, located above the bed 2 for installing the indoor unit 31, wherein the fixed frame 4 is fixed on a wall 51 of the room 5 through a fixed arm 41; and

a curtain 1, which is preferably made of airproof material, fixed and supported by the fixed frame 4 to form a cover 11, so as to enclose a small space 21 above the bed 2 to form an air conditioning space for restricting the cool air therein, thereby a desired low temperature is rapidly achieved in a short time while the electricity and cost both can be reduced.

When the curtain 1 fixed and supported by the fixed frame 4 is not in use, as shown in FIG. 3, it can be lifted to the two sides thereof and gathered behind a head 22 of the bed 2.

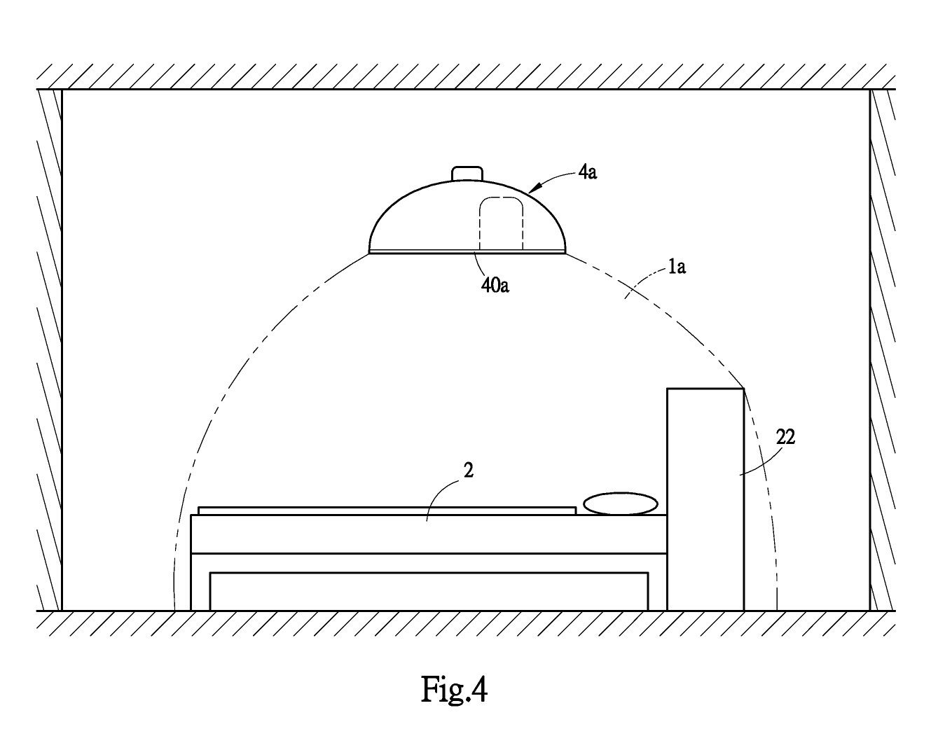

Further, please refer to FIG. 4 which shows another embodiment of the power saving apparatus according to the present invention. The fixed frame 4a has a track 40a on the periphery at the bottom thereof for mounting the curtain 1a. When the curtain 1a is not is use, it can be lifted and moved along the track 40a to be gathered behind the head 22 of the bed 2.

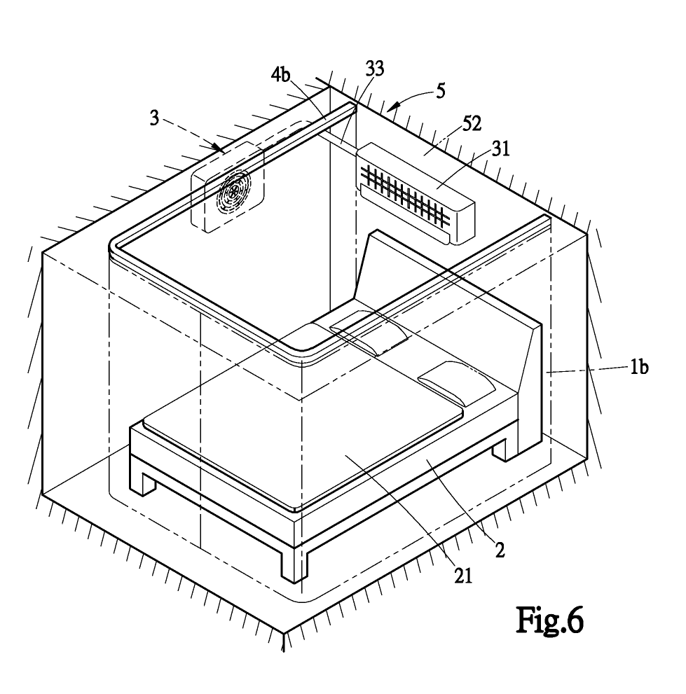

Please refer to FIG. 6 which shows yet another embodiment of the power saving apparatus according to the present invention. The fixed frame 4b is a track framework surrounding the bed 2 and mounted on the top wall 52 of the room 5. The curtain lb is mounted at the bottom of the fixed frame 4b for enclosing the bed 2 and the space above the bed 2 to form a small space 21. The indoor unit 31 of the split-typed air conditioner 3 is placed above the small space 21 or fixed on the wall of the room through the duct 33 and the curtain 1b. Then, the curtain lb can be moved along the track of the fixed frame 4b to be opened or closed. Therefore, through the curtain 1b which covers the bed 2 and the small space 21 thereabove to form the small air conditioning space, the cool air can be restricted therein and the desired low temperature can be rapidly achieved for save power and cost.

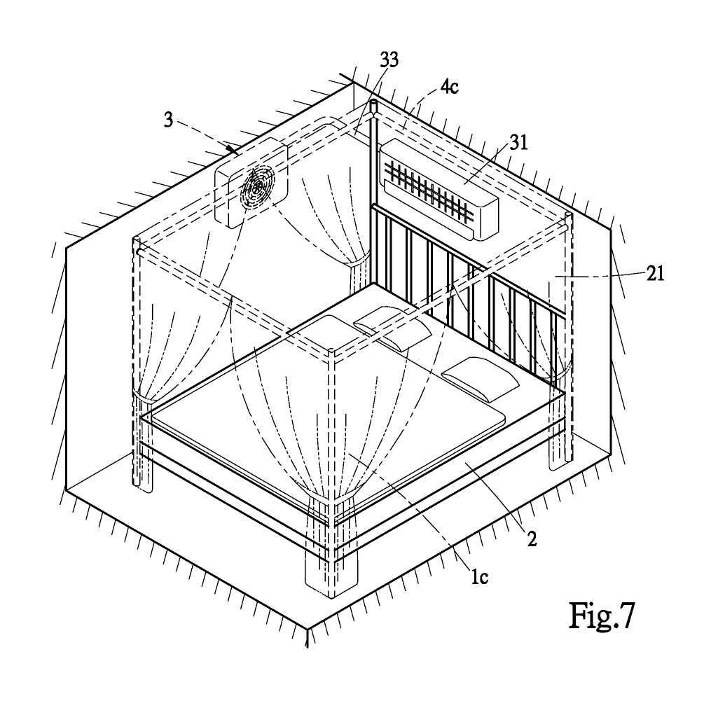

Please further refer to FIG. 7 which shows still another embodiment of the power saving apparatus according to the present invention. The fixed frame 4c is a framework mounted around the bed 2 and the curtain 1c covers the fixed frame 4c to enclose the bed 2 and the space thereabove to form a small space 21. The indoor unit 31 of the split-typed air conditioner 3 is placed above the small space 21 or fixed on the wall of the room through the duct 33. Therefore, through the curtain 1c which covers the bed 2 and the above small space 21 to form small air conditioning space, the cool air can be restricted therein and the desired low temperature can be rapidly achieved for saving power and cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for saving power of an air conditioner during sleep, comprising steps of:
providing a curtain to form a cover for enclosing a small space above a bed; and
placing an indoor unit of a split-typed air conditioner above the small space, so as to form a small air conditioning space.

2. The method as claimed in claim 1, wherein the curtain is made of an airproof material.

3. The method as claimed in claim 1, wherein the split-typed air conditioner is a 2000 BTU air conditioner.
